(19) United States
(12) Patent Application Publication
(10) Pub. No.: US 2008/0320502 A1
(43) Pub. Date: Dec. 25, 2008

(54) Providing Information about Software Components

(75) Inventors: Ashish Parikh, Issaquah, WA (US); Lars Axel Giusti, Shoreline, WA (US); Henry J. Lyons, Seattle, WA (US); Rahul Arun Chabukswar, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/765,488

(22) Filed: Jun. 20, 2007

(51) Int. Cl. G06F 3/00

(52) U.S. Cl. 719/328

(57) ABSTRACT

Aspects of the subject matter described herein relate to providing information about software components. In aspects, an interface is provided via which processes may request component information. The interface is publicly exposed and is callable by both local and remote procedures. In response to a request received at the interface, static information regarding one or more components is retrieved and combined with discovered dynamic information regarding the one or more components. This information is then transformed into a form suitable for sending via the interface.

### BACKGROUND

In large organizations, there may be hundreds of computers. Some of these computers may include servers that provide services to other computers both internal and external to the organization. In the past, determining which components are installed and executing on a particular server has been a time-consuming and mostly manual task.

### SUMMARY

Briefly, aspects of the subject matter described herein relate to providing information about software components. In aspects, an interface is provided via which processes may request component information. The interface is publicly exposed and is callable by both local and remote procedures. In response to a request received at the interface, static information regarding one or more components is retrieved and combined with discovered dynamic information regarding the one or more components. This information is then transformed into a form suitable for sending via the interface.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIGS. 2A-6B are block diagrams generally representing exemplary application programming interfaces that may operate in accordance with aspects of the subject matter described herein;

FIGS. 7 and 8 are block diagrams that generally represent how a compiler or interpreter may transform one or more interfaces to one or more other interfaces in accordance with aspects of the subject matter described herein;

FIG. 9 is a block diagram representing an exemplary environment in which aspects of the subject matter described herein may be implemented;

FIG. 10 is a block diagram that represents an exemplary device configured to operate in accordance with aspects of the subject matter described herein; and

FIG. 11 is a flow diagram that generally represents exemplary actions that may occur in accordance with aspects of the subject matter described herein.

### DETAILED DESCRIPTION

### Exemplary Operating Environment

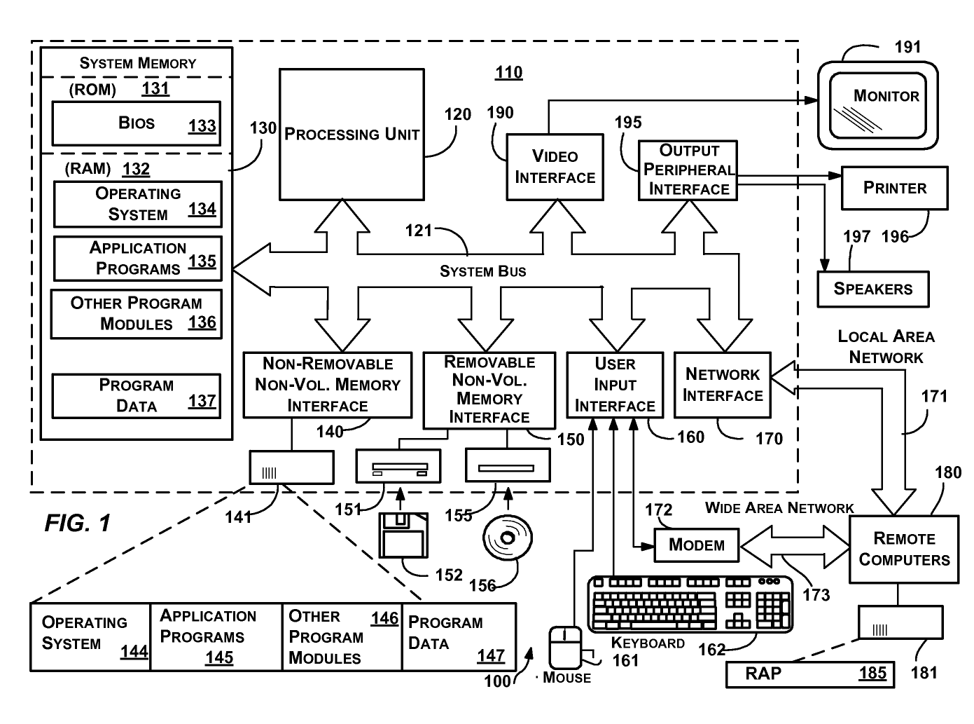

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and PCI Express (PCIe) bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Interfaces

A programming interface (or more simply, interface) may be viewed as any mechanism, process, or protocol for enabling one or more segment(s) of code to communicate with or access the functionality provided by one or more other segment(s) of code. Alternatively, a programming interface may be viewed as one or more mechanism(s), method(s), function call(s), module(s), object(s), and the like of a component of a system capable of communicative coupling to one or more mechanism(s), method(s), function call(s), module(s), and the like of other component(s). The term “segment of code” is intended to include one or more instructions or lines of code, and includes, for example, code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

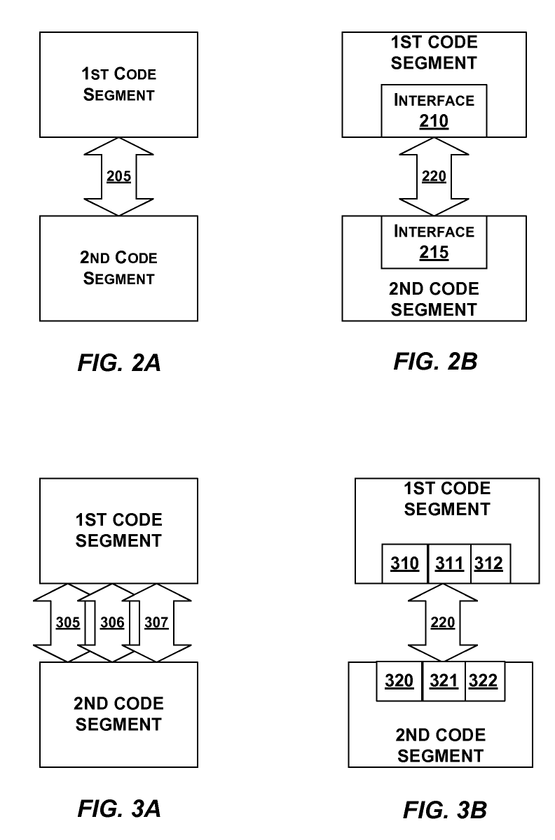

Notionally, a programming interface may be viewed generically, as shown in FIG. 2A or FIG. 2B. FIG. 2A illustrates an interface 205 as a conduit through which first and second code segments communicate. FIG. 2B illustrates an interface as comprising interface objects 210 and 215 (which may or may not be part of the first and second code segments), which enable first and second code segments of a system to communicate via medium 220. In the view of FIG. 2B, one may consider interface objects 210 and 215 as separate interfaces of the same system and one may also consider that objects 210 and 215 plus medium 220 comprise the interface. Although FIGS. 2A and 2B show bi-directional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing, and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g., information placed in a buffer, file, etc. separate from information flow between the code segments) or non-existent, as when one code segment simply accesses functionality performed by a second code segment. Any or all of these aspects may be important in a given situation, for example, depending on whether the code segments are part of a system in a loosely coupled or tightly coupled configuration, and so this list should be considered illustrative and non-limiting.

This notion of a programming interface is known to those skilled in the art and is clear from the foregoing detailed description. There are, however, other ways to implement a programming interface, and, unless expressly excluded, these too are intended to be encompassed by the claims set forth at the end of this specification. Such other ways may appear to be more sophisticated or complex than the simplistic view of FIGS. 2A and 2B, but they nonetheless perform a similar function to accomplish the same overall result. Below are some illustrative alternative implementations of a programming interface.

### A. Factoring

A communication from one code segment to another may be accomplished indirectly by breaking the communication into multiple discrete communications. This is depicted schematically in FIGS. 3A and 3B. As shown, some interfaces can be described in terms of divisible sets of functionality. Thus, the interface functionality of FIGS. 2A and 2B may be factored to achieve the same result, just as one may mathematically provide 24 as 2 times 2 times 3 times 2. Accordingly, as illustrated in FIG. 3A, the function provided by interface 205 may be subdivided to convert the communications of the interface into multiple interfaces 305, 306, 307, and so on while achieving the same result.

As illustrated in FIG. 3B, the function provided by interface 210 may be subdivided into multiple interfaces 310, 311, 312, and so forth while achieving the same result. Similarly, interface 215 of the second code segment which receives information from the first code segment may be factored into multiple interfaces 320, 321, 322, and so forth. When factoring, the number of interfaces included with the 1^{st} code segment need not match the number of interfaces included with the 2^{nd} code segment. In either of the cases of FIGS. 3A and 3B, the functional spirit of interfaces 205 and 210 remain the same as with FIGS. 2A and 2B, respectively.

The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

### B. Redefinition

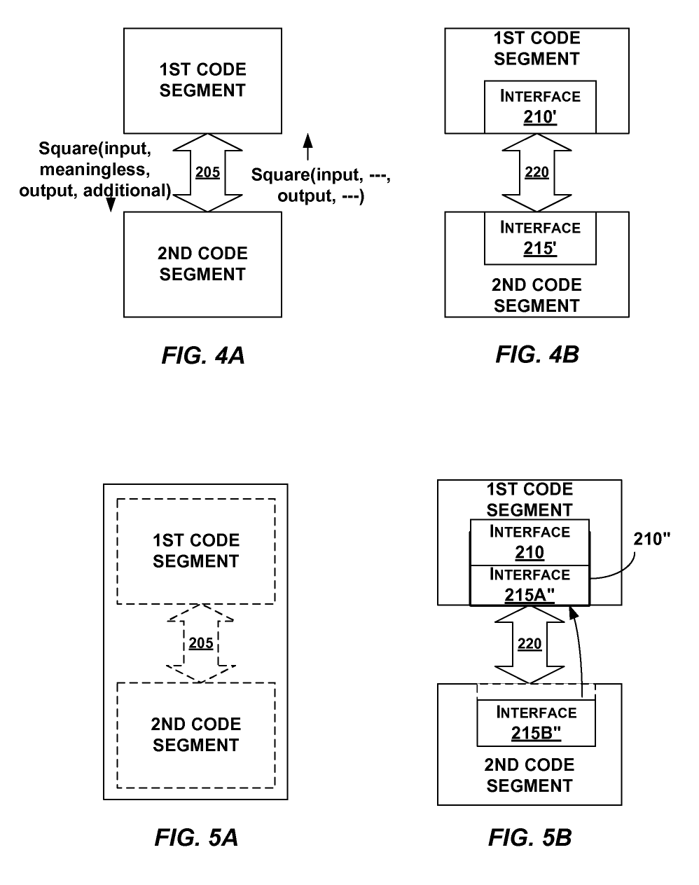

In some cases, it may be possible to ignore, add, or redefine certain aspects (e.g., parameters) of a programming interface while still accomplishing the intended result. This is illustrated in FIGS. 4A and 4B. For example, assume interface 205 of FIG. 2A includes a function call Square(input, precision, output), that includes three parameters, input, precision and output, and which is issued from the 1^{st} Code Segment to the 2^{nd} Code Segment. If the middle parameter precision is of no concern in a given scenario, as shown in FIG. 4A, it could just as well be ignored or even replaced with a meaningless (in this situation) parameter. An additional parameter of no concern may also be added. In either event, the functionality of square can be achieved, so long as output is returned after input is squared by the second code segment.

Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 4B, interface 210 is replaced by interface 210′, redefined to ignore or add parameters to the interface. Interface 215 may similarly be redefined as interface 215′, redefined to ignore unnecessary parameters, or parameters that may be processed elsewhere. As can be seen, in some cases a programming interface may include aspects, such as parameters, that are not needed for some purpose, and so they may be ignored or redefined, or processed elsewhere for other purposes.

### C. Inline Coding

It may also be feasible to merge some or all of the functionality of two separate code modules such that the “interface” between them changes form. For example, the functionality of FIGS. 2A and 2B may be converted to the functionality of FIGS. 5A and 5B, respectively. In FIG. 5A, the previous 1^{st} and 2^{nd} Code Segments of FIG. 2A are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface 205 may still be in effect. Similarly, shown in FIG. 5B, part (or all) of interface 215 from FIG. 2B may be written inline into interface 210 to form interface 210″. As illustrated, interface 215 is divided into 215A″ and 215B″, and interface portion 215A″ has been coded in-line with interface 210 to form interface 210”.

For a concrete example, consider that the interface 210 from FIG. 2B may perform a function call square (input, output), which is received by interface 215, which after processing the value passed with input (to square it) by the second code segment, passes back the squared result with output. In such a case, the processing performed by the second code segment (squaring input) can be performed by the first code segment without a call to the interface.

### D. Divorce

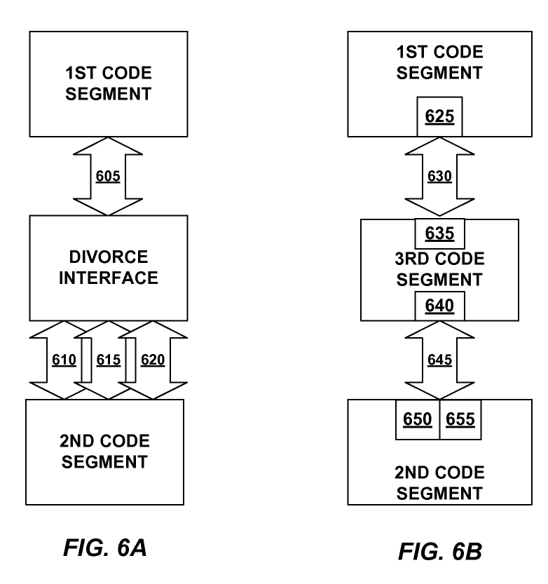

A communication from one code segment to another may be accomplished indirectly by breaking the communication into multiple discrete communications. This is depicted schematically in FIGS. 6A and 6B. As shown in FIG. 6A, one or more piece(s) of middleware (Divorce Interface(s), since they divorce functionality and/or interface functions from the original interface) are provided to convert the communications on the first interface 605, to conform them to a different interface, in this case interfaces 610, 615, and 620. This might be done, for example, where there is an installed base of applications designed to communicate with, say, an operating system in accordance with an the first interface 605's protocol, but then the operating system is changed to use a different interface, in this case interfaces 610, 615, and 620. It can be seen that the original interface used by the 2^{nd} Code Segment is changed such that it is no longer compatible with the interface used by the 1^{st} Code Segment, and so an intermediary is used to make the old and new interfaces compatible.

Similarly, as shown in FIG. 6B, a third code segment can be introduced with divorce interface 635 to receive the communications from interface 630 and with divorce interface 640 to transmit the interface functionality to, for example, interfaces 650 and 655, redesigned to work with divorce interface 640, but to provide the same functional result. Similarly, 635 and 640 may work together to translate the functionality of interfaces 210 and 215 of FIG. 2B to a new operating system, while providing the same or similar functional result.

### E. Rewriting

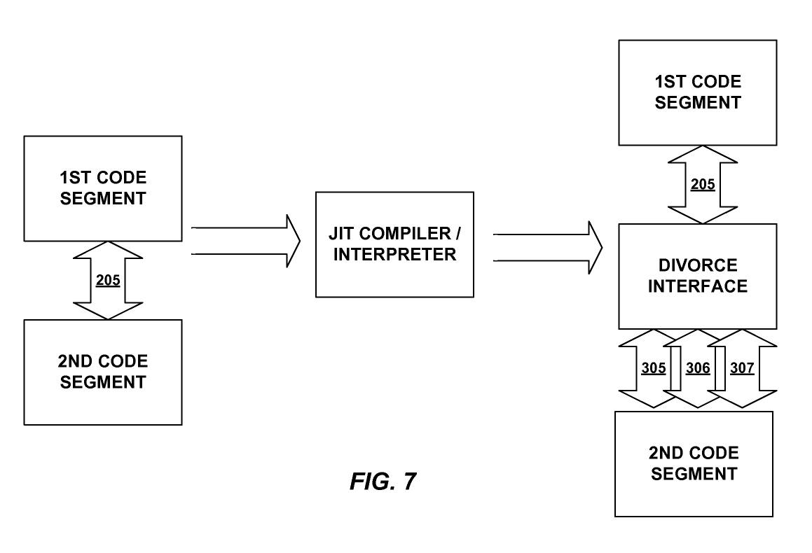

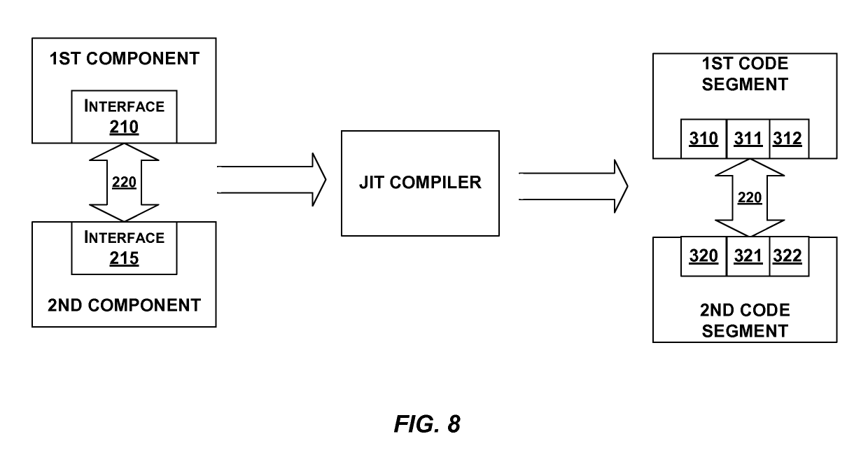

Yet another possible variant is to dynamically rewrite the code to replace the interface functionality with something else but which achieves the same overall result. For example, there may be a system in which a code segment presented in an intermediate language (e.g. Microsoft IL, Java® ByteCode, etc.) is provided to a Just-in-Time (JIT) compiler or interpreter in an execution environment (such as that provided by the .Net framework, the Java® runtime environment, or other similar runtime type environments). The JIT compiler may be written so as to dynamically convert the communications from the 1^{st} Code Segment to the 2^{nd} Code Segment, i.e., to conform them to a different interface as may be required by the 2^{nd} Code Segment (either the original or a different 2^{nd} Code Segment). This is depicted in FIGS. 7 and 8.

As can be seen in FIG. 7, this approach is similar to the Divorce scenario described above. It might be done, for example, where an installed base of applications are designed to communicate with an operating system in accordance with a first interface protocol, but then the operating system is changed to use a different interface. The JIT Compiler may be used to conform the communications on the fly from the installed-base applications to the new interface of the operating system. As depicted in FIG. 8, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched, and combined to produce the same or equivalent scenarios to the generic scenarios presented in FIGS. 2A and 2B. It is also noted that, as with most programming constructs, there are other similar ways of achieving the same or similar functionality of an interface which may not be described herein, but nonetheless are represented by the spirit and scope of the subject matter described herein, i.e., it is noted that it is at least partly the functionality represented by, and the advantageous results enabled by, an interface that underlie the value of an interface.

### Information Regarding Software Components

As mentioned previously, in the past, obtaining information about components installed on servers and updating the information to account for changes has been a time-consuming task. Information about a component may include, for example, whether the component is installed, what version of the component is installed, whether the component is running or not running, a human-readable name of the component, a parent of the component, if any, and the like.

In the past, a system administrator or the like might walk from machine to machine and execute administrative tools to determine what was installed on a machine. After doing this, the administrator might then determine which installed components were actually executing and which were simply installed but were not executing. To update the information about the components, the administrator would need to repeat the activities above.

In addition to, or in lieu of, being a physical machine, a “server” (sometimes referred to as a “server application”) may comprise a software application that is equipped to carry out tasks on behalf of, or provide services to, one or more client applications. One common example of a server application is a web server application, which is equipped to receive requests for information from clients executing a browser application. The web server application processes the requests that are received and provides the information to the client applications.

In general, the services that a server is equipped to perform on behalf of clients correspond to, and are defined by, the modules or components of the server application that are installed or otherwise implemented on the computer(s) on which the server application executes, and the decision of the computer's user to cause such modules or components to be executed, either continuously, periodically, or on demand. Overall, the services that a server application makes available to clients may be thought of as “roles” which the server performs for the clients.

A server may be equipped to perform a wide variety of roles. For example, depending on the modules of the server application that are installed or implemented, a server may play the role of a file server, print server, mail server, web application server, terminal server, remote access and/or virtual private network (VPN) server, directory services server, streaming media server, or other server role. A server may perform any number of roles at a time.

A component as used herein indicates one or more pieces of software that may be installed on a server. In some embodiments, one or more components may be grouped by or associated with a role or service of a server. In other embodiments, no grouping or association is required. Unless the context makes clear otherwise, whenever the term “component” is used herein, in one embodiment, this term is to replaced by “role.” In other embodiments, the term “component” is to remain as is and is to be defined as described previously.

Furthermore, although the term server is often used herein, it will be recognized that this term may also encompass a device that often acts as a client, a set of one or more processes distributed on one or more computers, one or more stand-alone storage devices, a set of one or more other devices, a combination of one or more of the above, and the like that is capable of providing services to other processes and/or devices.

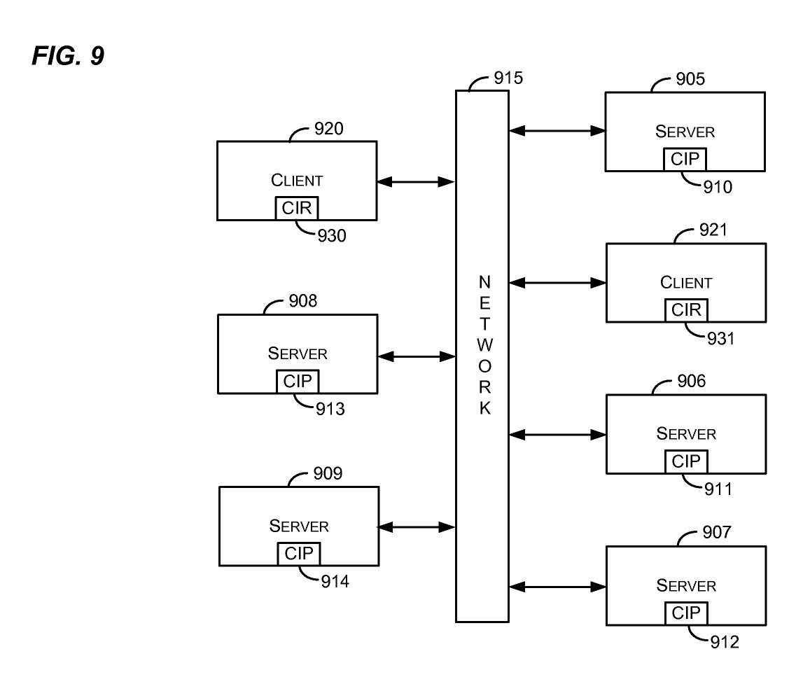

FIG. 9 is a block diagram representing an exemplary environment in which aspects of the subject matter described herein may be implemented. The environment includes servers 905-909 and clients 920-921 and may include other components (not shown). The various entities may communicate with each other via various networks including intra- and inter-office networks and the network 915. In one embodiment, the network 915 may comprise the Internet.

Each of the servers 905-909 and the clients 920-921 may be implemented on one or more computers (e.g., computer 110 as described in conjunction with FIG. 1). The servers 905-909 may include component information providers 910-914, respectively, that provide information about components of the servers 905-909. In one embodiment, a component information provider includes an interface that other processes (both internal and external to the server) may use to find out component information for components that reside on the server.

The clients 920-921 may include component information requesters 930-931, respectively, that allow the clients 920-921 to request the information about components on any of the servers 905-909. In one embodiment, a component information requester may comprise any process on a client that issues a request to a component information provider. A client may issue such a request through a remote procedure call (RPC). Some exemplary architectures that support remote procedure calls are Distributed Component Object Model (DCOM), ActiveX, Simple Object Access Protocol (SOAP), Microsoft® net, Java's Remote Method Invocation (Java RMI), Common Object Request Broker Architecture (CORBA), and others known to those skilled in the art. Most, if not all, of these architectures hide the complexity of passing parameters to a remote procedure. From a programmer's perspective, calling a procedure on a remote device via an RPC via one of these architectures may be as simple as calling a local procedure.

In one embodiment, the component information requesters 930-931 may communicate with the component information providers 910-914 via Windows® Management Instrumentation (WMI). WMI may incorporate SOAP, DCOM, or another transport to communicate information between the requesters and the providers.

In another embodiment, the component information providers 910-914 may be Web services that provide the component information to processes (e.g., component information requesters 930-931) that request the information.

A component information requester may comprise a script, a browser configured to send an appropriate request, an application having a graphical user interface for displaying component information, a database component that collects information from servers and places the information in a database, a service that periodically collects the information and places it in volatile or non-volatile memory, some other process, and the like.

A component information requester may have a capability of querying more than one component information provider. For example, a component information requester may be able to respond to a request to obtain components information for all components for a selected set of servers.

Although the environment described above includes five servers and two clients, it will be recognized that more, fewer, or a different combination of these entities may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

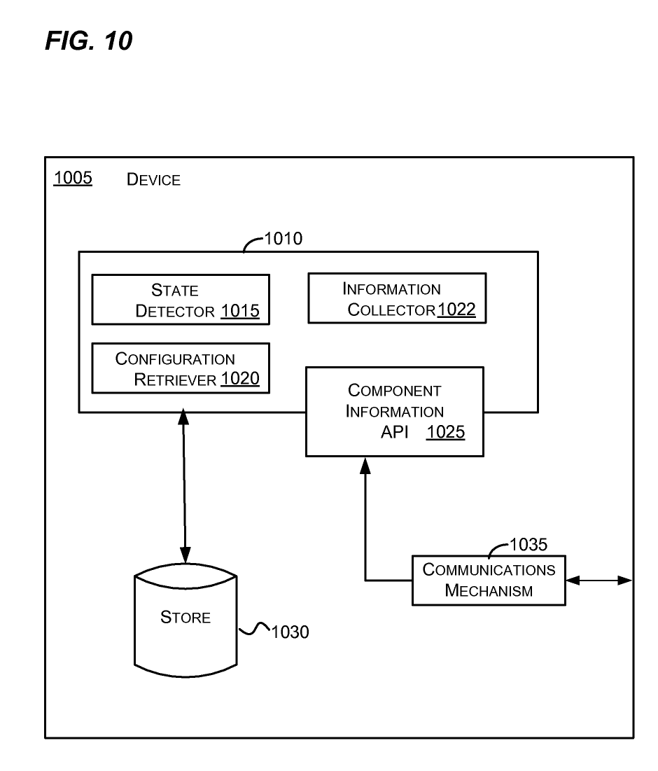

FIG. 10 is a block diagram that represents an exemplary device configured to operate in accordance with aspects of the subject matter described herein. The device 1005 may include a component information provider 1010, a store 1030, and a communications mechanism 1035. The component information provider 1010 may include a state detector 1015, a configuration retriever 1020, an information collector 1022, and a component information API 1025. The device 1005 may correspond to one of the servers 905-909 of FIG. 9. The component information provider 1010 corresponds to the component information providers 910-914 of FIG. 9.

The communications mechanism 1035 allows the device 1005 to communicate with other devices to provide information regarding the components on the device 1005. The communications mechanism 1035 may be a network interface or adapter 170, modem 172, or any other mechanism for establishing communications as described in conjunction with FIG. 1.

The store 1030 is any storage media capable of storing configuration information regarding the components. The store 1030 may comprise a file system, database, volatile memory such as RAM, other storage, some combination of the above, and the like and may be distributed across multiple devices. The store 1030 may be external or internal to the device 1005.

The component information API 1025 provides a mechanism for requesting and transmitting information about the component information. A local or remote process may call the interface to obtain information about the components. In one embodiment, the component information API 1025 may be defined as follows:

```
class ComponentInfo
{
    [key, Not_NULL(True), Read(True), Write(False)]
    uint32 ID;
    [Not_NULL(True), Read(True), Write(False)]
    string State;
    [Read(True), Write(False)]
    uint32 ParentID;
    [Read(True), Write(False)]
    string Name;
};
```

The first parameter, ID, may uniquely identify a component of the server. In one embodiment, the ID may not be NULL and it may be read from the server but not changed via the API 1025. In another embodiment, the ID may be read and changed via the API 1025.

The second parameter, State, may indicate a state of the component including one or more of not applicable, not installed, installed, not running, and running. In another embodiment, additional states that may be indicated by the state parameter may include, for example, blocked, waiting, continue pending, pause pending, start pending, stop pending, started, starting, stopped, paused, any other state information, and the like. As used herein, the term “pending” may refer to any one or more of the pending states above. It is recognized that the list of states above is exemplary and that more, fewer, and/or different states may be found in a particular implementation without departing from the spirit or scope of the subject matter described herein.

Not applicable indicates that the component is installed, but it is unknown whether the application is running or not. Not running indicates that the component is installed but not running. Running indicates that the component is installed and running. In one embodiment, the State may not be NULL and it may be read from the server but not changed via the API 1025. In another embodiment, the State may be read and changed via the API 1025.

The third parameter, ParentID identifies a parent of the component if one exists. Some components may have subcomponents which may have subcomponents and so forth. Some subcomponents may only be able to operate if their parent component is installed and operating. The ParentID property may be set to zero if the component has no parent and may be set to NULL if the parent component cannot be determined. In one embodiment, the ParentID may be read from the server but not changed via the API 1025. In another embodiment, the ParentID may be read and changed via the API 1025.

The fourth parameter, Name, indicates a name of the component. In one embodiment, the name is specified in a particular language (e.g., English) no matter where the server is located. In another embodiment, the name is specified in a language as desired by a software developer, system administrator, or the like. In some embodiments, the Name may be NULL if the display name of the component cannot be determined. In one embodiment, the Name may be read from the server but not changed via the API 1025. In another embodiment, the name may be read and changed via the API 1025.

While four parameters have been indicated above, in other embodiments, more, fewer, and/or different parameters may be allowed by the API 1025. For example, in one embodiment, the API may accept a query that asks whether a certain component is installed on the server. In this embodiment, the API may obtain an ID parameter, determine whether the component is installed, and may then return an installation state. In another embodiment, other state (e.g., running, not running, etc.) of the component may be desired. In this embodiment, the API 1025 may receive an ID of the component and may return the other state of the component. In other embodiments, some other combination or permutation of the parameters above may be needed. In some embodiment, the minimum types of parameters are a parameter that identifies the component and a parameter (or return data structure) that provides some information about the component.

Other exemplary information that may be passed via the API 1025 is history information about the installation of a component. For example, a system administrator may desire to know when a component was installed. This information may be included in the store 1030. With the appropriate parameter or method call, the API 1025 can provide this history information.

Other exemplary information that may be passed via the API 1025 is a list of services that are associated with a component. As mentioned previously, a component may be associated with one or more other components in a hierarchical manner, for example. This association may be stored in the store 1030. With the appropriate parameter or method call, the API 1025 can provide a list of the services associated with a particular component and the state of each of the services.

Other exemplary information that may be passed via the API 1025 includes a list of one or more components that a server is capable of executing. Certain components, for example, may require certain resources such as a certain number or type of processors, memory, hard disk space, and so forth. The API 1025 may include a parameter or method that allows a component information requester to ask whether a certain component may be executed on a particular server or may ask to return a list of components that a server is capable of executing.

It will be recognized by those skilled in the art that many types of information regarding components may be passed via the API 1025 without departing from the spirit or scope of aspects of the subject matter described herein.

Furthermore, while the parameters above have been specified in a particular order, in other embodiments, the parameters may be in other orders.

In operation, the device 1005 may receive a request for information about components installed thereon. This request may be received through the communications mechanism 1035 and passed to the component information API 1025. The request may be passed via a security mechanism if desired. The component information API 1025 may call the information collector 1022 to obtain the information requested in the query.

The information collector 1022 may first call the configuration retriever 1020 to obtain information from the store 1030. The information obtained from the store 1030 may include such things as component identifiers, names of components, identifiers of parent component of the components, if any, and other information as indicated previously. Using this information, the information collector 1022 may query the state detector 1015 to obtain state information (e.g., running, installed, not executing, blocked, etc.) regarding the components.

In obtaining this information, the information collector 1022 may create a data structure that includes the information requested via the component information API 1025. The information collector 1022 may fill out this data structure with information retrieved from both the configuration retriever 1020 and the state detector 1015. In some embodiments, static information (e.g., ID, parent, and name) regarding the components is obtained from the configuration retriever 1020 while dynamic information (e.g., running, not running, installed, etc.) is obtained from the state detector 1015.

After the information collector 1022 has assembled the information, the information collector 1022 may translate the information into a format suitable to be transmitted via the component information API 1025. This may involve extracting data from the information and placing the data in a data structure suitable to be sent via the API 1025. For example, if the component information provider is a provider for a WMI infrastructure, the information collector 1022 may translate the information into a format suitable for that infrastructure. As another example, the form returned may include the fields indicated in the class ComponentInfo indicated above.

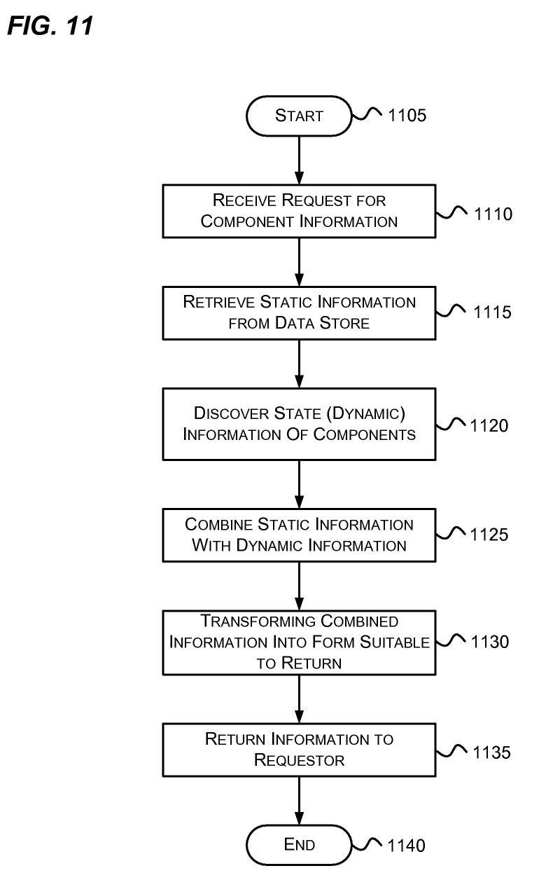

FIG. 11 is a flow diagram that generally represents exemplary actions that may occur in accordance with aspects of the subject matter described herein. For simplicity of explanation, the methods described in conjunction with FIG. 11 are depicted and described as a series of acts. It is to be understood and appreciated that the aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methods in accordance with aspects of the subject matter described herein. In addition, those skilled in the art will understand and appreciate that the methods could alternatively be represented as a series of interrelated states via a state diagram or as events.

Turning to FIG. 11, at block 1105, the actions begin. At block 1110, an interface receives a request for component information. For example, referring to FIG. 10, the component information API 1025 receives a request for information about components installed on the device 1005.

At block 1115, static information is retrieved from a data store. The data store may comprise a data file, a registry, a general purpose database, an XML, HTML, or other document, a data structure in memory or on disk, and the like. For example, referring to FIG. 10, the configuration retriever 1020 retrieves identifier, name, and parentID from the store 1030 of components that may or may not be installed on the device 1005. The store 1030 may explicitly indicate which components are installed, which components are not installed, and which components were once installed but have since been removed.

At block 1120, state information of the components is discovered. State information includes dynamic information (i.e., information that may change depending on whether the component is installed, running, blocked, waiting, not running, etc.). For example, referring to FIG. 10, the state detector 1015, discovers state information about components or about a particular component about which a request for information has been received at block 1110.

At block 1125, the static information is combined with the dynamic information. The actions associated with block 1125 may be performed in parallel with the actions associated with blocks 1115 and 1120. For example, a data structure may be filled in with static information from the data store. As the state of each component is discovered, this information may be entered into the data structure.

At block 1130, the combined information is transformed into a form suitable for return via the interface. For example, referring to FIG. 10, the information collector 1022 may extract data from the data structure into which the dynamic and static information was placed and may format this data into another data structure suitable for presenting at the component information API 1025.

At block 1135, the information requested is returned to the requester. For example, referring to FIG. 9, information from the component information provider 910 may be sent to the component information requester 930.

At block 1140, the action end.

As can be seen from the foregoing detailed description, aspects have been described related to providing information about software components. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving a request for information about a component;
retrieving static information about the component from a data store;
discovering state information about the component;
combining the static information with the state information in a data structure; and
sending a response that includes or is derived from the data structure.

2. The method of claim 1, wherein the request is received at an application programming interface, the request including at least an identifier of the component.

3. The method of claim 1, wherein the static information comprises a human-readable name associated with the component.

4. The method of claim 1, wherein the static information comprises an identifier of a parent component of the component.

5. The method of claim 1, wherein the static information comprises date information regarding when the component was installed.

6. The method of claim 1, wherein the state information comprises one or more of not applicable, not installed, installed, not running, running, blocked, waiting, pending, started, starting, stopped, and paused.

7. The method of claim 1, wherein receiving a request for information about a component comprises receiving a request for one or more components that a server is capable of executing.

8. The method of claim 1, further comprising extracting data from the data structure to place in a data structure suitable for the response.

9. At least one computer-readable medium containing instructions which when executed by a computer, perform actions, comprising:
at an interface, receiving an instruction to provide information about a component, the information relating to static and dynamic information regarding the component, the instruction being received from a process executing on a device other than a device upon which the interface resides, the instruction including a parameter that identifies the component;
parsing the instruction to obtain the parameter; and
in response to the request, providing the information at the interface.

10. The at least one computer-readable medium of claim 9, wherein the interface is suitable for receiving remote procedure calls.

11. The at least one computer-readable medium of claim 9, wherein the component performs a role in which the component provides one or more services to other processes.

12. The at least one computer-readable medium of claim 9, wherein the dynamic information comprises not applicable, installed but not running, and running.

13. The at least one computer-readable medium of claim 9, wherein the static information comprises a human-readable name of the component.

14. The at least one computer-readable medium of claim 9, wherein the static information comprises a parent identifier of the component.

15. The at least one computer-readable medium of claim 9, wherein the process performs actions of a script, an application having a graphical user interface for displaying the information, a database component that collects the information, or a service that periodically collects the information.

16. In a computing environment, an apparatus, comprising:
an interface operable to receive requests for component information and further operable to respond thereto, a component corresponding to the component information residing, if installed, on a server that includes the interface, the interface being publicly exposed to local and remote procedure calls;
a configuration retriever operable to obtain configuration information about the component;
a state detector operable to detect state information about the component; and
an information collector operable to combine the configuration information with the state information.

17. The apparatus of claim 16, wherein the component information includes properties of the component, the properties not being changeable via the interface.

18. The apparatus of claim 16, wherein the configuration retriever operates to retrieve configuration information about the component by retrieving the configuration information from a store, the store including an installation dates of a component, a human-readable component name, and parent component information for each component installed on the server.

19. The apparatus of claim 16, wherein the state information comprises not installed, installed but unknown as to running, installed and running, blocked, and waiting.

20. The apparatus of claim 16, wherein the information collector is further operable to transform combined information into a form suitable for presenting via the interface.
